(19) United States
(12) Patent Application Publication
(10) Pub. No.: US 2013/0229958 A1
(43) Pub. Date: Sep. 5, 2013

(54) BASE STATION AND RESOURCE ALLOCATION METHOD OF MOBILE COMMUNICATION SYSTEM

(71) Applicants: Yuta Sagae, Chiyoda-ku (JP); Hiroyuki Ishii, Chiyoda-ku (JP); Naoto Ookubo, Chiyoda-ku (JP); Anil Umesh, Chiyoda-ku (JP)

(72) Inventors: Yuta Sagae, Chiyoda-ku (JP); Hiroyuki Ishii, Chiyoda-ku (JP); Naoto Ookubo, Chiyoda-ku (JP); Anil Umesh, Chiyoda-ku (JP)

(73) Assignee: NTT DOCOMO, INC., Tokyo (JP)

(21) Appl. No.: 13/885,698

(22) PCT Filed: Nov. 28, 2011
(86) PCT No.: PCT/JP2011/077405

§ 371 Date: May 16, 2013

(30) Foreign Application Priority Data
Dec. 6, 2010 (JP) 2010-271750

(51) Int. Cl. H04W 72/04

(52) U.S. Cl. CPC H04W 72/0406
USPC 370/281

(57) ABSTRACT

The base station includes a scheduler controller that controls scheduling operations of a downlink and an uplink. The scheduler controller controls the scheduling operation of the DL and the UL in accordance with a first criterion such that a subframe of user equipment which includes UL data starts, prior to termination of a subframe of base station not including DL data, a second criterion such that the subframe of the user equipment which does not include the UL data starts, prior to the termination of the subframe of the base station including the DL data, or a third criterion such that the subframe of the user equipment which includes a signal other than an ACK/NACK starts, prior to the termination of the subframe of the base station including the DL data.

### TECHNICAL FIELD

The present invention relates to a base station and a resource allocation method of a mobile communication system.

### BACKGROUND ART

A time division duplex (TDD) scheme and a frequency division duplex (FDD) scheme are duplex schemes that can be used for a mobile communication system. The time division duplex (TDD) scheme is a scheme such that a time period for transmission and a time period for reception are alternately switched in the same frequency. The frequency division duplex (FDD) scheme enables, in principle, simultaneous transmission and reception by separately setting a frequency band for transmission and a frequency band for reception. However, for a case where the frequency band for the transmission and the frequency band for the reception are relatively close to each other, if user equipment (UE) receives a downlink signal and transmits an uplink signal at the same time, it is possible that an out-of-band signal of the transmitted uplink signal becomes desense noise in a receiving band of the downlink signal. From such a perspective, as a frequency division duplex scheme, a duplex scheme is proposed in which control is performed so that no downlink signals are allocated during transmission of an uplink signal. This scheme is referred to as a “half duplex frequency division duplex (Half Duplex FDD) scheme” (cf. Non-Patent Document 1, for example).

Meanwhile, a distance from an eNodeB (eNB) to user equipment (UE) varies depending on a position of the user equipment (UE). Thus, a propagation delay period between the base station (eNB) and the user equipment (UE) varies depending on the user equipment (UE). Because of the effect of the propagation delay period, when user equipment (UE) receives a downlink signal and subsequently performs transmission while being synchronized with a downlink frame of the downlink signal, reception timing to reach the eNodeB (eNB) varies depending on the user equipment (UE). In this case, since it is difficult to separate received signals at the eNodeB (eNB), quality of the uplink signal is lowered. For this reason, a method is utilized where transmission timing of an uplink signal is shifted depending on the propagation delay period, so that uplink signals from corresponding units of user equipment (UE) reach the eNodeB (eNB) at the same time. Namely, prior to termination of a downlink subframe from the eNodeB (eNB), an uplink subframe from the user equipment (UE) is started. The eNodeB (eNB) can simultaneously receive uplink signals from various units of the user equipment placed at corresponding various locations within the cell.

FIG. 1 shows downlink subframes (eNB-DL) from the eNodeB (eNB) and uplink subframes (UE-UL) from user equipment (UE). Here, the downlink subframes (eNB-DL) from the eNodeB (eNB) and the uplink subframes (UE-UL) from the user equipment (UE) are shown while they are synchronized with reception timing of receiving the downlink subframes by the user equipment (UE). In general, during transmission of downlink subframes from the eNodeB (eNB), the user equipment (UE) does not transmit uplink subframes having the same subframe numbers as those of the corresponding downlink subframes. Similarly, during transmission of uplink subframes from the user equipment (UE), the eNodeB (eNB) does not transmit downlink subframes having the same subframe numbers as those of the corresponding uplink subframes.

As shown in the figure, in order to compensate a propagation delay period between the eNodeB (eNB) and the user equipment (UE), timing of the uplink subframes from the user equipment (UE) precedes by an amount corresponding to a certain time difference, relative to timing of the downlink subframes from the eNodeB (eNB). The eNodeB (eNB) calculates timing differences of the transmission timing while considering conditions of other units of user equipment (UE), and the timing differences are reported to the corresponding units of the user equipment (UE). By doing this, the propagation delay period between the eNodeB (eNB) and the user equipment (UE) can be compensated. In general, the time difference is equal to a time period required for traveling a round-trip distance between the eNodeB (eNB) and the user equipment (UE). However, the control variable of the time difference is determined based on an algorithm implemented in the eNodeB (eNB). That is because both the propagation delay period in the downlink and the propagation delay period in the uplink are to be addressed. If such a time difference exists, it is possible that an uplink subframe of the user equipment (UE) is started, prior to termination of a downlink subframe from the eNodeB (eNB) to the user equipment (UE), even in a case where subframes of different subframe numbers are transmitted and received. Namely, it occurs when the transmission from the eNodeB (eNB) in the downlink is switched to the transmission from the user equipment (UE) in the uplink. For example, for a case of an LTE system, user equipment (UE) that receives a downlink data signal in a certain subframe is to transmit an acknowledgement signal (ACK/NACK) in a subframe, which is four subframes after the certain subframe. Accordingly, if a downlink data signal is transmitted immediately prior to such an acknowledgement signal (ACK/NACK), the uplink subframe starts prior to termination of the downlink subframe. Additionally, for bidirectional communication such as a telephone, since traffic occurs which simultaneously utilizes an uplink and a downlink, a phenomenon similar to the above-described phenomenon may occur.

In such a situation, since the user equipment (UE) transmits an uplink signal while receiving a downlink signal, the uplink signal becomes the desense noise of the downlink signal. To address the effect of the noise, it is considered to allow the user equipment (UE) to abandon reception of the last part of the corresponding downlink subframe, namely, it is considered to allow the user equipment (UE) to ignore the last part (cf. Non-Patent Document 2). In this condition, the last part to be ignored depends on an adjustment amount of the transmission timing of each of the units of the user equipment (UE). Accordingly, when the subframe includes seven OFDM symbols or six OFDM symbols, depending on the length of the cyclic prefix, in general, it is approximately one OFDM symbol. Nevertheless, the number of the OFDM symbols to be ignored depends on the size of the cell. For a cell having a radius of approximately 10 km, about one symbol is sufficient. For a greater cell, the OFDM symbols to be ignored may be two or more OFDM symbols.

Meanwhile, data modulation and channel coding are applied to a signal transmitted by the eNodeB (eNB) in the downlink, in accordance with the adaptive modulation and channel coding (AMC) scheme. Several combinations of data modulation schemes and channel coding schemes (types of transmission formats) are defined in advance. The combination to be utilized is specified by a modulation and channel coding scheme (MCS), a MCS number, or a MCS level. The MCS level is adaptively selected depending on a throughput to be achieved. In this case, a signal transmitted by a single subframe is channel-coded on the basis of a unit called a “code block.” Depending on the MCS level, the size of the code block may be several symbols, one symbol, or plural subcarriers in one symbol. In general, for a MCS level for a low throughput, the size of the code block is several symbols. In contrast, for a MCS level for a high throughput, the size of the code block is, for example, an amount corresponding to a single OFDM symbol. Alternatively, one OFDM symbol may include several code blocks. Here, a code block may not be mapped while the code block is distributed in a direction of the OFDM symbols (time direction).

FIG. 2 shows a relationship between a downlink subframe and code blocks for a case of a low MCS level. In the figure, the colored portion indicates a portion including a downlink shared data signal, which is for the corresponding user equipment (UE). For a case where a low MCS level is selected, a single code block is mapped onto several OFDM symbols, such as the portion surrounded by the thick frame. For the case of the figure, the size of the code block is an amount of successive four OFDM symbols. The size of the code block is the unit of the channel coding. The eNodeB (eNB) maps the error correction coded code block onto the whole four symbols including the last symbol. In this case, if the symbols other than the last symbol are suitably received, the data corresponding to the four symbols can be demodulated based on the received three OFDM symbols, even if the user equipment (UE) ignores the last one symbol. This case corresponds to a case where a code rate of the error correction coding is set to be large. In general, the success rate of the demodulation for this case is lowered, but the effect is small. For example, error detection of a cyclic redundancy check (CRC) method is performed with respect to the whole single subframe. For a case where the data of the above-described four symbols is suitably demodulated, the result of the error detection with respect to this subframe is “OK” (which shows that no errors are detected), provided that the preceding symbols are suitably demodulated.

### RELATED ART DOCUMENT

### Non-Patent Document

Non-Patent Document 1: 3GPP TSG RAN WG1#51bis, TdocR1-080598, Seville, Spain, Jan. 14-18, 2008
Non-Patent Document 2: 3GPP TSG-RAN WG1#51bis, R1-080534, Seville, Spain, Jan. 14-18, 2008 (2.4 Guard time for downlink-to-uplink switch)

### SUMMARY OF THE INVENTION

### Problem to be Solved by the Invention

FIG. 3 shows a relationship between a downlink subframe and code blocks, for a case of a high MCS level. In the figure, the colored portion indicates a portion including a downlink shared data signal, similar to FIG. 2. For a case where the MCS level is high, the number of the OFDM symbols onto which a single code block is mapped is small, compared to a case where the MCS level is low. Unlike FIG. 2, the number of OFDM symbols onto which the code block is mapped is small, such as the portions surrounded by the corresponding thick frames. In the figure, one code block is mapped onto each of the OFDM symbols. However, for a case where the MCS level is high, several code blocks may be mapped onto a single OFDM symbol. In this example, the user equipment (UE) performs error correction processing on a symbol-by-symbol basis. In this case, when the user equipment (UE) ignores the last symbol included in a subframe, since the last symbol itself is not received, there is no information regarding the corresponding code block, and the information may not be suitably demodulated, even if the symbols other than the last symbol are successfully received. Especially, since it is not possible to map a code block while the code block is distributed in the direction of the OFDM symbols (the time direction), it is difficult to retrieve the information regarding the code block, which is only mapped onto the last symbol.

The error detection by the CRC is performed with respect to the whole single subframe. Since the last symbol is not suitably demodulated, the result of the error detection with respect to the whole subframe may be “NG” (which indicates that an error is detected), even if the code blocks other than the code block mapped onto the last part of the downlink subframe are successfully received. This result of the error detection (NG) is caused by ignoring the last symbol by the user equipment (UE). It is not true that the reception has failed due to a bad radio channel condition. Thus, it is significantly different from a generic result of the error detection.

Additionally, since a communication state and a packet error status significantly depend on the channel condition, transmission is performed at a MCS level corresponding to a predetermined receiving quality level (e.g., a ratio between a level of a desired signal and a noise level). However, it is expected that, in reality, the channel condition are different from a simulated channel. Accordingly, the eNodeB (eNB) can cause the MCS level to be adaptively varied, so that the error rate becomes a target value, in response to a report (ACK/NACK signal) regarding the result of the error detection from the user equipment (UE). For example, the MCS level is adjusted so that a block error rate becomes 10⁻¹.

In such a situation, when the eNodeB (eNB) is notified of the detection result of “NG” regarding the subframe, as a result that the user equipment ignores the last symbol as described above, the eNodeB (eNB) lowers the MCS level, so that the error rate becomes the target value. For example, suppose that the HD-FDD scheme is utilized for a case where the FDD scheme can be utilized. In this case, even if the receiving condition is a condition where a high throughput can be achieved, for example, by a combination of a data modulation scheme of 64 QAM and a channel coding rate of ⅞, a MCS level is assigned which can only achieve a low throughput, such as a combination of the data modulation scheme of the QPSK and the channel coding rate of ½, in order to respond to the error caused by ignoring the last OFDM symbol. Consequently, even if the quality of the actual radio channel condition is so fine that the target value of the error rate can be completely achieved, the MCS level that can only achieve the low throughput is used for this user. In this case, radio resources utilized by other users may also be affected. From a perspective of resource utilization efficiency, such a situation is not preferable.

An objective of the present invention is to solve, in a mobile communication system in which an uplink subframe from user equipment is started, prior to termination of a downlink subframe from a base station, so that the propagation delay period between the base station and the user equipment is compensated, a problem such that, when the uplink subframe is allocated immediately after the downlink subframe, and when a function of the user equipment to ignore the last part of the downlink subframe is allowed, an error occurs in the downlink subframe due to the function that ignores the last part. Additionally, another objective of the present invention is to solve the problem that only a low MCS level is assigned in spite of an environment in which a high MCS level can be utilized.

### Means for Solving the Problem

According to an aspect of an embodiment of the present invention, there is provided a base station of a mobile communication system that performs communication based on a half duplex frequency division duplex. The base station includes a scheduler controller that controls scheduling operations for a downlink and an uplink; a UL scheduler that performs scheduling of a control signal and a data signal in the uplink in accordance with the scheduler controller; and a DL scheduler that performs scheduling of the control signal and the data signal in the downlink in accordance with the scheduler controller, based on downlink channel quality information measured by user equipment and an error detection result with respect to the data signal received by the user equipment. In the mobile communication system, a frame is repeated such that in the frame a first predetermined number of downlink subframes are continued, and subsequently a second predetermined number of uplink subframes are continued. The scheduler controller controls the scheduling operations of the downlink and the uplink in accordance with a first criterion such that the uplink subframe of the user equipment starts, prior to termination of the downlink subframe of the base station, wherein the uplink subframe includes the control signal or the data signal, and the downlink subframe does not include the control signal and does not include the data signal; a second criterion such that the uplink subframe of the user equipment starts, prior to the termination of the downlink subframe of the base station, wherein the uplink subframe does not include the control signal and does not include the data signal, and the downlink subframe includes the control signal or the data signal; or a third criterion such that the uplink subframe of the user equipment starts, prior to the termination of the downlink subframe of the base station, wherein the uplink subframe includes a signal other than an acknowledgement signal, and the downlink subframe includes the control signal or the data signal.

### Effect of the Present Invention

According to one embodiment, the problem can be solved such that only a low MCS level for a lower throughput is assigned to the user equipment. The lower throughput is lower than that of a MCS level that can be used for an actual condition of a radio channel.

### BRIEF DESCRIPTION OF THE DRAWINGS

FIG. 1 is a diagram showing a DL subframe from a eNodeB and a UL subframe from user equipment;

FIG. 2 is a diagram showing a relationship between a subframe and code blocks for a case of a low MCS level;

FIG. 3 is a diagram showing a relationship between a subframe and code blocks for a case of a high MCS level;

FIG. 4 is a diagram showing a communication system used in an embodiment;

FIG. 5 is a functional block diagram regarding scheduling of a base station;

FIG. 6 is a diagram illustrating an assignment method according to a first criterion;

FIG. 7 is a diagram illustrating an assignment method according to a second criterion;

FIG. 8 is a diagram showing an example of a frame format that can be used in the embodiment;

FIG. 9 is a diagram illustrating an assignment method for a case where the frame format of FIG. 8 is used;

FIG. 10 is a diagram showing an example of assignment for the case where the frame format of FIG. 8 is used;

FIG. 11A is a diagram illustrating an assignment method according to a third criterion; and

FIG. 11B is a diagram illustrating the assignment method according to the third criterion.

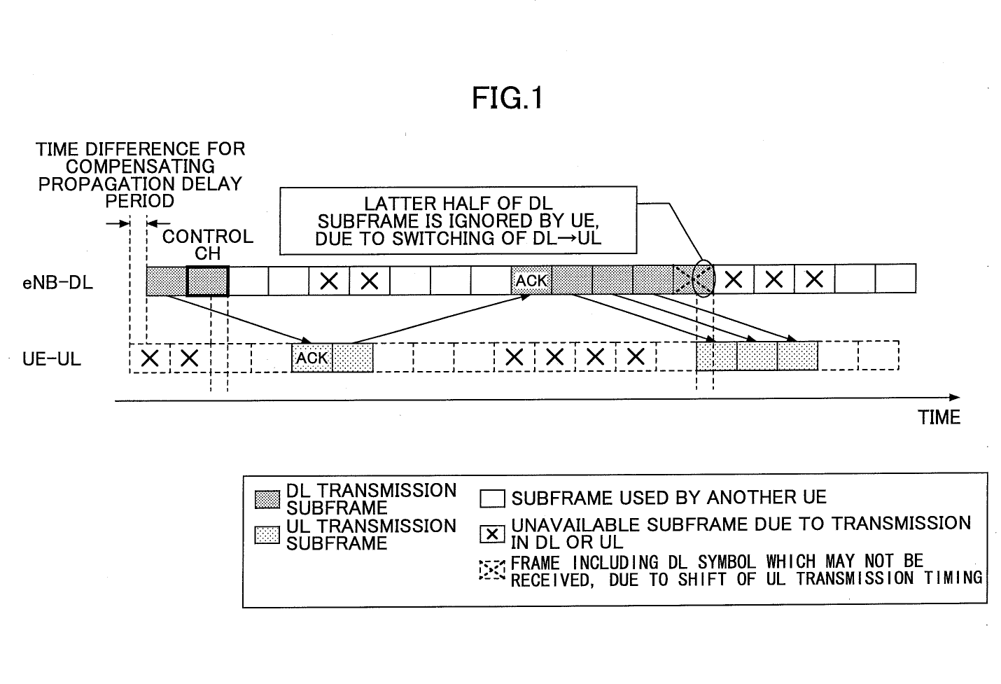

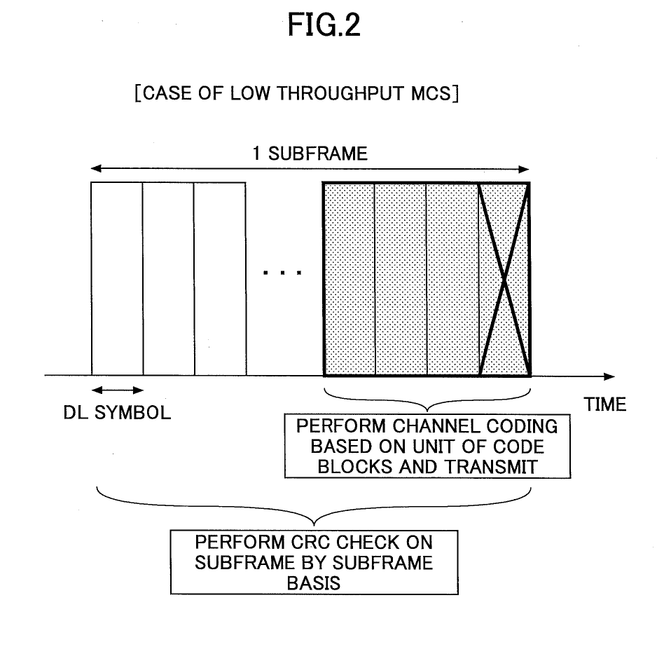

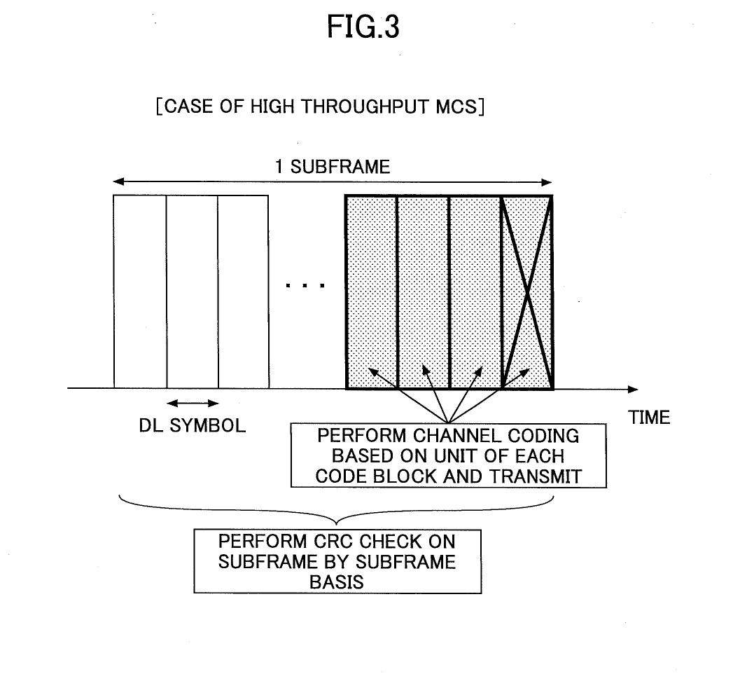

### EMBODIMENTS FOR CARRYING OUT THE INVENTION

An embodiment is explained from the following perspectives.

1. Communication system

2. eNodeB

3. Resource allocation method

3.1 First method

3.2 Second method

3.3 Third method

4. Modified examples

4.1 First modified example

4.2 Second modified example

4.3 Third modified example

### Embodiment

### 1. Communication System

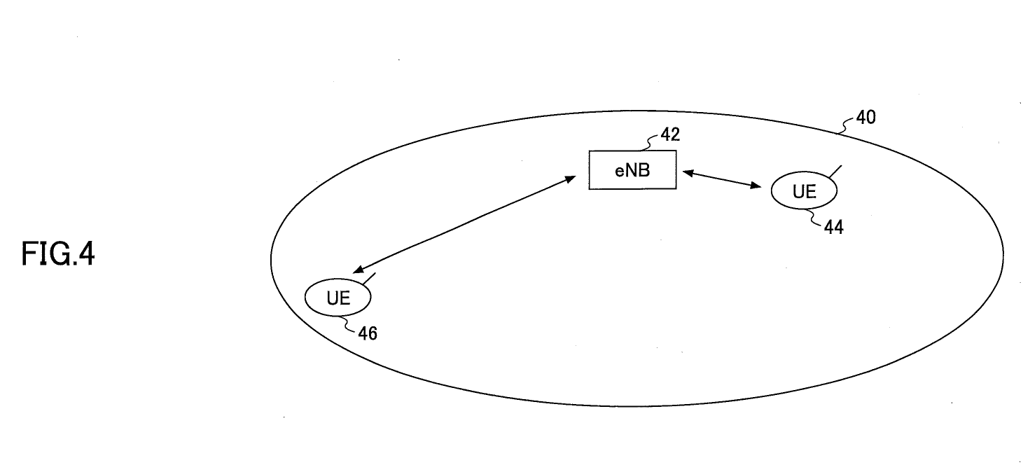

FIG. 4 shows a communication system which is used in the embodiment. FIG. 4 shows a eNodeB (eNB) 42 located inside a cell 40 and units of user equipment (UE) 44 and 46. For convenience of explanation, the communication system is assumed to be a Long Term Evolution (LTE) system. However, the embodiment is not limited to this example, and the embodiment may be applied to any suitable communication system. For example, it may be applied the Mobile WiMax or the IEEE802.16m. Typically, the user equipment (UE) is a mobile terminal. However the user equipment (UE) may be a fixed terminal. Specifically, the user equipment (UE) may be a mobile phone, an information terminal, a smart phone, a personal digital assistant, a mobile personal computer, or the like. However, the user equipment (UE) is not limited to these.

Communications of a downlink and an uplink are performed by allocating one or more resource blocks (RB: Resource Block) to the user equipment (UE) in the communication system. Plural resource blocks included in the system are shred by plural units of user equipment. As an example, a resource block has a frequency bandwidth of 180 kHz, and a time period of 1 ms. Further, one resource block includes seven or six OFDM symbols, depending on the length of its cyclic prefix. An OFDM symbol in the downlink is a symbol generated in accordance with the OFDM method. A symbol in the uplink is a symbol generated in accordance with the SC-FDMA (or the DFT-Spread) method. For each subframe (Sub-frame) of 1 ms, the eNodeB determines which user equipment is to be allocated resource blocks, among the plural units of the user equipment. The subframe may be referred to as a “Transmission Time Interval (TTI).” The process of determining the allocation of the radio resources is referred to as “scheduling.” For the downlink, the eNodeB transmits a shared channel signal to the user equipment, which is selected by the scheduling, by using one or more resource blocks. This shared channel is referred to as a “Physical Downlink Shared CHannel (PDSCH).” For the uplink, the user equipment, which is selected by scheduling, transmits a shared channel signal to the eNodeB by using one or more resource blocks. This shared channel is referred to as a “Physical Uplink Shared CHannel (PUSCH).”

For a communication system using such shared channels, in principle, it may be required to perform signaling (to report) regarding user equipment, to which the shared channels are allocated, for each subframe. The control channel used for this signaling is referred to as a “Physical Downlink Control Channel (PDCCH: Physical Downlink Control CHannel)” or a DL-L1/L2 Control Channel. The downlink control signal may include, in addition to the PDCCH, a Physical Control Format Indicator Channel (PCFICH: Physical Control Format Indicator Channel) and a Physical Hybrid ARQ Indicator Channel (PHICH: Physical Hybrid ARQ Indicator CHannel), for example.

The PDCCH may include, for example, the following information:
Downlink Scheduling Grant,
Uplink Scheduling Grant, and
Transmission Power Control Command Bit.

The downlink scheduling grant includes, for example, information regarding a downlink shared channel. Specifically, the downlink scheduling grant includes information regarding allocation of downlink resource blocks, identification information of user equipment (UE-ID), information regarding a stream number and a Pre-coding Vector, and information regarding a data size, a data modulation scheme, and a hybrid automatic repeat request (HARQ), for example.

The uplink scheduling grant includes, for example, information regarding an uplink shared channel. Specifically, the uplink scheduling grant includes information regarding allocation of uplink resources, the identification information of the user equipment (UE-ID), a data size, a data modulation scheme, uplink transmission power information, and information regarding a demodulation reference signal for an uplink MIMO, for example.

The PCFICH is information for reporting a format of the PDCCH. Specifically, the PCFICH reports the number of the OFDM symbols onto which the PDCCH is mapped. For LTE, the number of the OFDM symbols onto which the PDCCH is mapped is one, two, or three. The PDCCH is mapped successively from the top OFDM symbol in a subframe.

The PHICH includes acknowledgement/non-acknowledgement (ACK/NACK) information that indicates whether retransmission is required for the PUSCH which was transmitted in the uplink.

For the uplink, user data (a normal data signal) and control information accompanying the user data are transmitted by the PUSCH. Apart from the PUSCH, quality information of the downlink (CQI: Channel Quality Indicator) and acknowledgement/non-acknowledgement (ACK/NACK) information of the PDSCH are transmitted by the Physical Uplink Control Channel (PUCCH). The CQI is used for a scheduling process of the physical downlink shared channel and for an adaptive modulation and coding scheme (AMCS: Adaptive Modulation and Coding Scheme), for example. In the uplink, a random access channel (RACH) and signals indicating a request for allocation of the uplink radio resources and a request for allocation of the downlink radio resources are transmitted, depending on necessity.

### 2. eNodeB

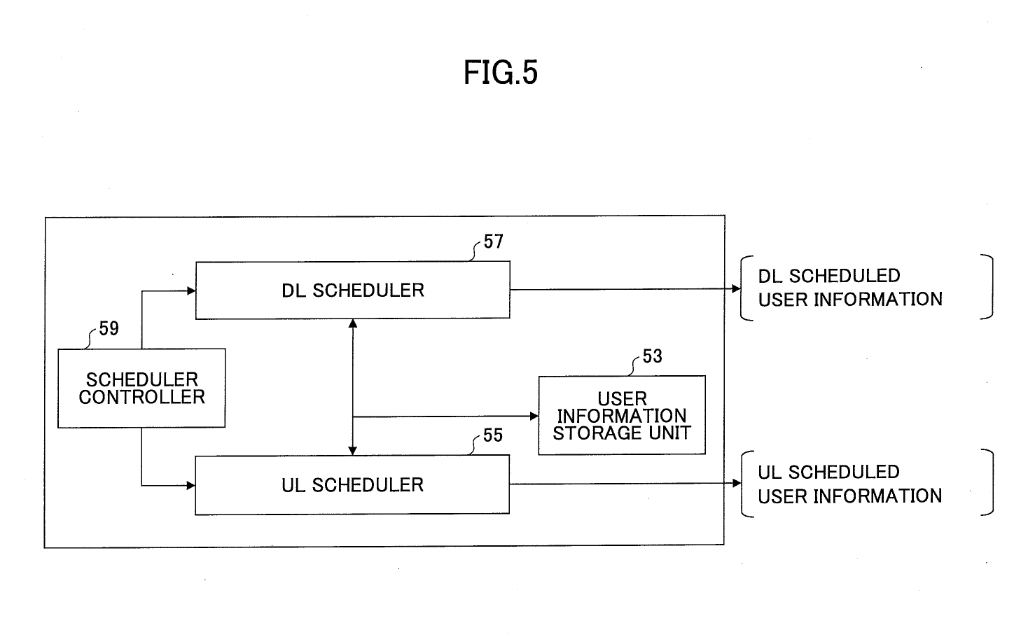

FIG. 5 shows a functional block diagram regarding the scheduling of the eNodeB (eNB). The eNodeB (eNB) includes a communication unit for performing radio communication and wired communication, and various processing units such as a measurement unit that measures a channel state of the uplink. However, these are not shown.

FIG. 5 shows a user information storage unit 53; a UL scheduler 55; a DL scheduler 57; and a scheduler controller 59.

The user information storage unit 53 saves information regarding user traffic data, which is transmitted to the user in the downlink. After the user traffic data is transmitted, the user traffic data is reserved for a while. In this manner, the user traffic data is prepared for retransmission, in order to address an error which may occur in the user equipment (UE). Additionally, the user information storage unit 53 stores the user traffic data which is received from the user equipment in the uplink.

The UL scheduler 55 performs scheduling of an uplink control signal and an uplink data signal. For example, a reception level of a sounding reference signal (SRS) transmitted from the user equipment (UE) is measured for each of the resource blocks, and thereby one or more resource blocks are determined, which are suitable for the uplink transmission by the user equipment (UE). Further, an MCS level is determined, so that an error rate with respect to the uplink shared data channel from the user equipment (UE) satisfies a predetermined value.

Though it is not described in the figure, in order to compensate a propagation delay period between the eNodeB and the user equipment, the eNodeB (eNB) has a function to control transmission timing of each of units of the user equipment (UE), so that an uplink subframe of the user equipment starts prior to termination of a downlink subframe of the eNodeB. The time difference for compensating the propagation delay period is approximately equal to a time period required for traveling the round-trip distance between the eNodeB (eNB) and the user equipment (UE). That is for addressing both the propagation delay period in the downlink and the propagation delay period in the uplink.

The DL scheduler 57 performs scheduling of a downlink control signal and a downlink data signal. In general, one or more resource blocks which are suitable for the downlink transmission to the user equipment (UE) are determined, based on channel quality information (CQI) of the downlink which is received from the user equipment (UE) and an error detection result with respect to the shared data channel which is received by the user equipment (UE). Further, for determining the MCS level of the downlink shared data channel to the user equipment (UE), the MCS level is adjusted, so that the error rate satisfies a predetermined value, besides the CQI information.

As explained in detail below, the scheduler controller 59 controls scheduling operations of the UL scheduler 55 and the DL scheduler 57.

### 3. Resource Allocation Method

The scheduler controller 59 controls scheduling in accordance with, at least, any of a first through a third criteria.

3.1 First Method

The first criterion is such that an uplink subframe of the user equipment which includes an uplink control signal or an uplink data signal starts, prior to termination of a downlink subframe of the eNodeB which does not include a control signal and which does not include a data signal.

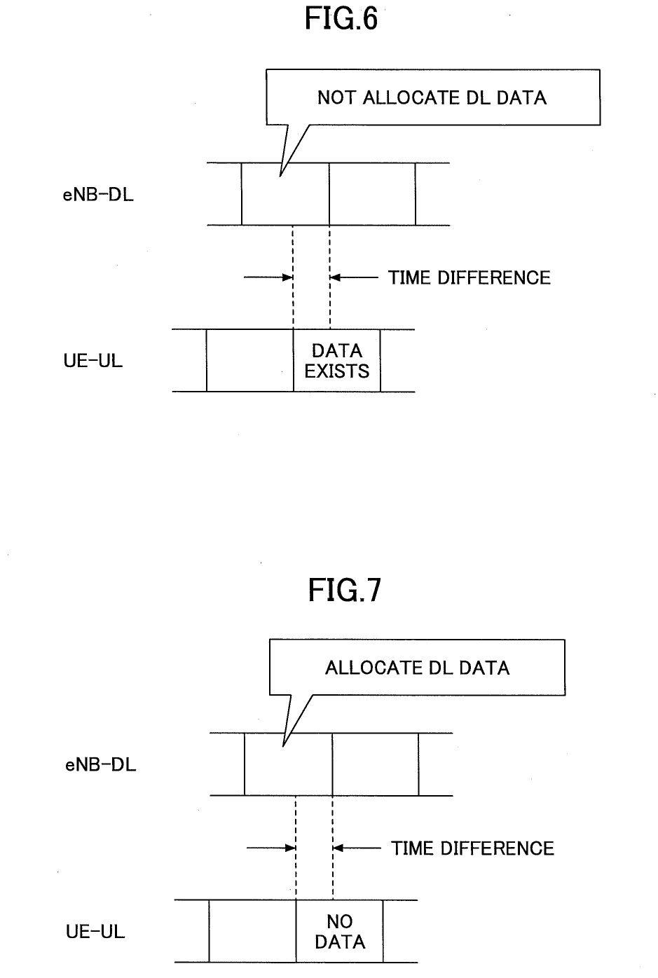

FIG. 6 is a diagram for illustrating an allocation method based on the first criterion. In order to compensate the propagation delay period, the uplink subframe of the user equipment (UE) is shifted by a predetermined time difference with respect to the downlink subframe of the eNodeB (eNB). When data is transmitted in an uplink subframe, downlink data is not transmitted in a subframe immediately preceding the uplink subframe. The downlink data in this case may be a control signal or a data signal.

In this manner, it can be avoided that the user equipment (UE) transmits an uplink signal while receiving a downlink signal.

3.2 Second Method

The second criterion is such that an uplink subframe of the user equipment which does not include a control signal and which does not include a data signal starts, prior to termination of a downlink subframe of the eNodeB including a control signal or a data signal.

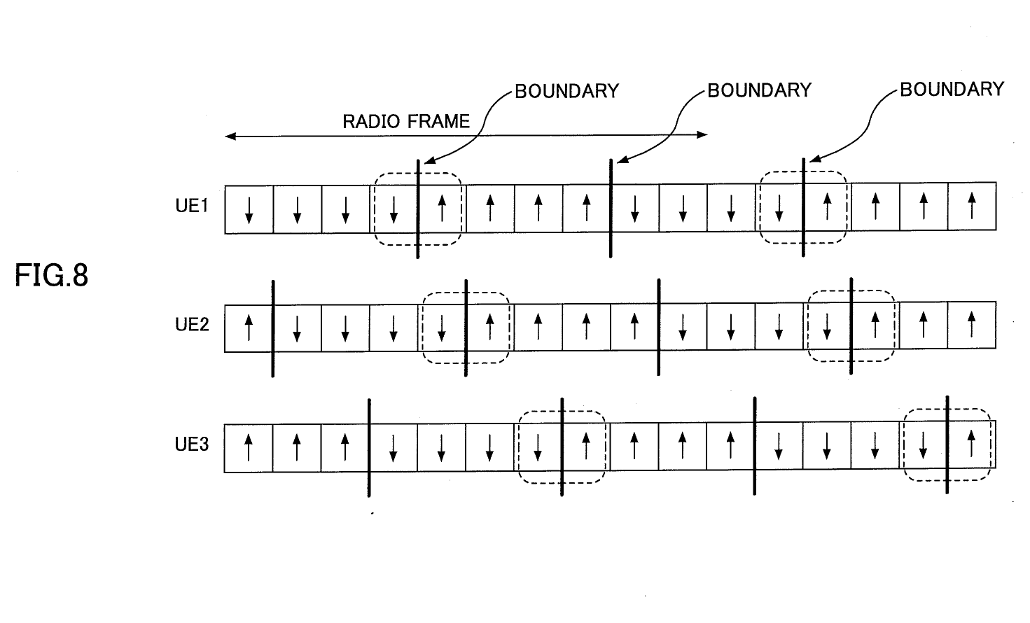

FIG. 7 is a diagram illustrating an allocation method based on the second criterion. Similar to FIG. 6, an uplink subframe of the user equipment (UE) is shifted by a predetermined time difference with respect to a downlink subframe of the eNodeB (eNB), in order to compensate the propagation delay period. When no data is transmitted in an uplink subframe, downlink data may be transmitted in a subframe immediately preceding the uplink subframe. The downlink data in this case is also a control signal or a data signal.

In this manner, it can be avoided that the user equipment (UE) transmits an uplink signal while receiving a downlink signal. In this case, the user equipment (UE) can receive all the downlink signals including the last symbol.

Alternatively, in the second and the third criteria, when a boundary between a downlink subframe and an uplink subframe is already known, downlink data may not be transmitted in the subframe immediately preceding the boundary, regardless of whether uplink data is transmitted in the following subframe.

In order to make the boundary between the downlink subframe and the uplink subframe be known, it can be considered to define a frame such that a first predetermined number of subframes to be allocated to the downlink are followed by a second predetermined number of subframes to be allocated to the uplink.

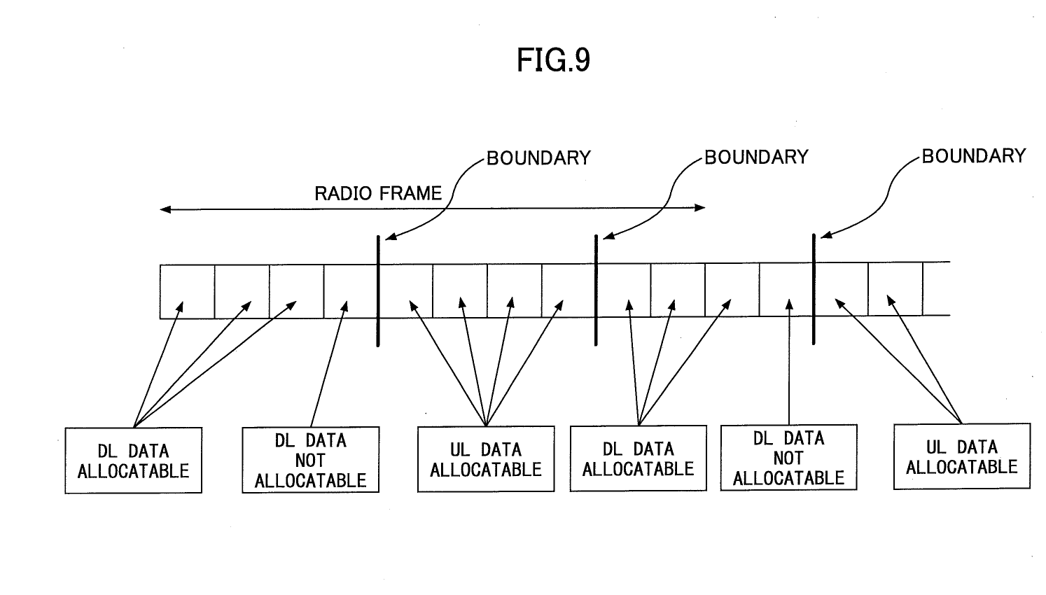

FIG. 8 shows an example of such a frame. In the example shown in the figure, both the first predetermined number and the second predetermined number are four. However, any number may be used. For example, the first predetermined number for the downlink may be set to be greater than the second predetermined number for the uplink. By defining a format of such a frame, it can be known in advance that at what timing switching from the downlink to the uplink occurs. Namely, it can be known in advance that at what timing the problem to be solved by the embodiment occurs. For the case of the example shown in the figure, the above-described problem is concerned for the subframes, which are surrounded by the dashed lines.

Additionally, the timing at which the boundary between the uplink and the downlink occurs may be set for each user. For the case of the example shown in the figure, the timing at which the boundary between the uplink and the downlink occurs is different depending on each of the units of the user equipment UE1-UE3. In this manner, the number of the users can be reduced, for which the exceptional processing, such as of the first and second criteria, is simultaneously performed.

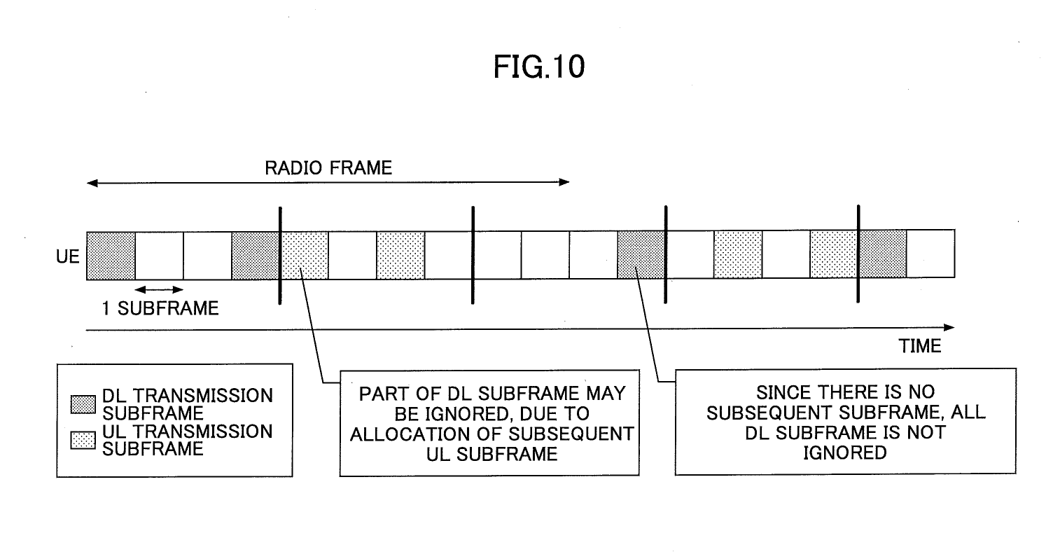

FIG. 9 shows a situation where data is not transmitted in the subframe immediately preceding the boundary, for a case where a frame such as shown in FIG. 8 is utilized. In the figure, the DL data indicates downlink data, and the UL data indicates uplink data.

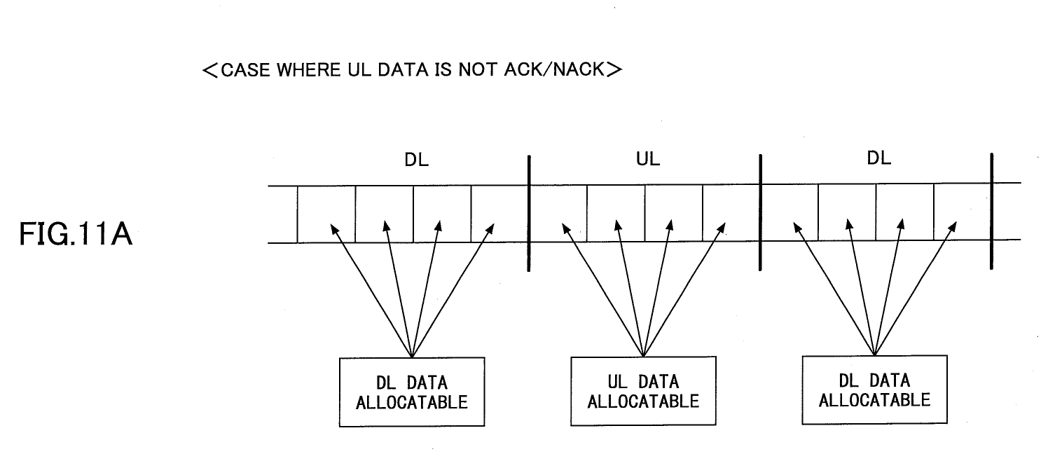

FIG. 10 shows a situation where the DL data and the UL data are actually allocated, for the case where the frame such as shown in FIG. 8 is utilized.

3.3 Third Method

The third criterion is such that an uplink subframe of the user equipment (UE) which includes a specific traffic signal other than the acknowledgement signal (ACK/NACK) starts, prior to termination of a downlink subframe of the eNodeB (eNB) including a control signal or a data signal. For radio communication, there are no fatal effects, even if the acknowledgement signal (ACK/NACK) indicating whether a downlink data signal is successfully received is transmitted a little late. Similar to a case where the eNodeB (eNB) receives negative acknowledgement (NACK), the eNodeB merely starts a retransmission process, when the acknowledgement signal (ACK/NACK) is not received by the eNodeB (eNB) within a predetermined time period. From such a perspective, scheduling is performed, so as to avoid transmitting an acknowledgement signal (ACK/NACK) in the uplink immediately after a downlink data subframe. In this case, since no uplink signals are transmitted in the subframe immediately after the downlink data subframe, the user equipment (UE) can properly receive the symbols in the downlink subframe, including the last part. For the case of the third criterion, processes are performed as usual for specific traffic signals other than the acknowledgement signal (ACK/NACK). Namely, uplink data may be transmitted in a subframe immediately after a downlink data subframe. In this case, the user equipment may ignore the last one symbol of the downlink data subframe.

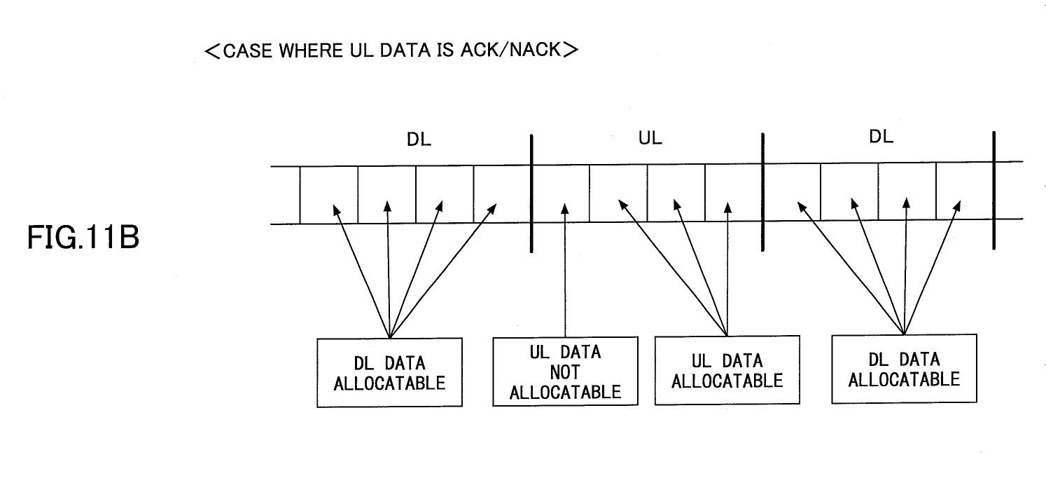

FIGS. 11A and 11B shows whether the downlink data (DL data) and uplink data (UL data) can be transmitted, for a case where the third criterion is applied.

### 4. Modified Examples

### 4.1 First Modified Example

As explained in the column of “PROBLEM TO BE SOLVED BY THE INVENTION,” the problem that a proper MCS level may not be selected by ignoring the last part of the downlink subframe becomes particularly worse for a case where an MCS level is utilized with which a high throughput can be achieved. Accordingly, the scheduling based on the above-described second and third criteria may be performed only for a case where data of such a high MCS level is transmitted. An eNodeB or an operator may suitably determine whether an MCS level is high or low. For example, a case where a size of a code block is less than or equal to one symbol may be defined to be a high MCS level, and the second or third scheduling may be performed only for that case. Alternatively, a case where the size of the code block is less than or equal to two symbols may be defined to be the high MCS level, and the second or third scheduling may be performed only for that case.

### 4.2 Second Modified Example

As explained by referring to FIG. 8, the frame including the first predetermined number of the downlink subframes and the second predetermined number of the downlink subframes may be repeated. Whereas, the user equipment (UE) may be required to report the downlink channel quality information (CQI) to the eNodeB (eNB), periodically or on demand. Thus, a frequency of reporting the channel quality information CQI can be a multiple of the frame. For example, for a case where a frame including four downlink subframes and four downlink subframes is repeated, a period is defined by a multiple of 8 pieces of subframes (e.g., 16 TTI), and the channel quality information CQI can be reported, at least, based on that period.

Additionally, for a case where a radio frame including a predetermined number of subframes has already been defined for an existing system, a time period corresponding to the least common multiple of a time period of the above-described frame and a time period of the existing radio frame may be defined to be a frequency of reporting the channel quality information. For example, in a LTE system, the radio frame includes 10 subframes. In this case, a frequency can be a time period corresponding to 40 subframes, which is the least common multiple of 8 and 10.

### 4.3 Third Modified Example

As described above, in response to receiving a report on the error detection result from the user equipment (UE), the eNodeB (eNB) controls the MCS level for a downlink data signal, so that the error rate becomes a target value. In this case, the eNodeB (eNB) may determine the MCS level, not based on all the error detection result. The eNodeB (eNB) may ignore a part of the error detection result, and may determine the MCS level, based on the remaining part of the error detection result. Specifically, the MCS level may be determined without considering the error detection result with respect to a downlink subframe of the eNodeB, which is terminated after an uplink subframe of the user equipment (UE) is started. By doing this, the likelihood can be decreased such that a MCS level for a downlink data signal is lowered to be a MCS level for an unreasonably low throughput. In this case, the scheduling based on the above-described first through third criteria can be concurrently utilized.

In the present technique, one radio frame is formed of ten subframes. In this case, a control signal which is reported by a specific number included in one radio frame may not be received. However, it suffices if such a control signal is received at a rate of once per several radio frames. The communication can be continued without any problems by reporting the control signal by a subframe which is assigned, at the rate of once per several radio frames, as timing for downlink transmission.

Hereinabove, the present invention is explained by referring to the specific embodiments. However, the embodiments are merely illustrative, and variations, modifications, alterations and substitutions could be conceived by those skilled in the art. For example, the present invention may be applied to any suitable communication system which utilizes the half duplex frequency division duplex (Half Duplex FDD). For example, the present invention may be applied to a W-CDMA system, an HSDPA/HSUPA based W-CDMA system, an LTE system, an LTE-Advanced system, an IMT-Advanced system, a WiMAX system, and a Wi-Fi system. Specific examples of numerical values are used in order to facilitate understanding of the invention. However, these numerical values are simply illustrative, and any other appropriate values may be used, except as indicated otherwise. The separations of the embodiments or the items are not essential to the present invention. Depending on necessity, subject matter described in two or more items may be combined and used, and subject matter described in an item may be applied to subject matter described in another item (provided that they do not contradict). For the convenience of explanation, the devices according to the embodiments of the present invention are explained by using functional block diagrams. However, these devices may be implemented in hardware, software, or combinations thereof. The software may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like. The present invention is not limited to the above-described embodiments, and various variations, modifications, alterations, substitutions and so on are included, without departing from the spirit of the present invention.

The present international application claims priority based on Japanese Patent Application No. 2010-271750, filed on Dec. 6, 2010, the entire contents of which are hereby incorporated by reference.

### LIST OF REFERENCE SYMBOLS

40: Cell
42: eNodeB (eNB)
44, 46: User equipment (UE)
53: User information storage unit
55: UL scheduler
57: DL scheduler
59: Scheduler controller

1. A base station of a mobile communication system that performs communication based on a half duplex frequency division duplex, the base station comprising:
a scheduler controller that controls scheduling operations for a downlink and an uplink;
a UL scheduler that performs scheduling of a control signal and a data signal in the uplink in accordance with the scheduler controller; and
a DL scheduler that performs scheduling of the control signal and the data signal in the downlink in accordance with the scheduler controller, based on downlink channel quality information measured by user equipment and an error detection result with respect to the data signal received by the user equipment,
wherein, in the mobile communication system, a frame is repeated such that in the frame a first predetermined number of downlink subframes are continued, and subsequently a second predetermined number of uplink subframes are continued, and
wherein the scheduler controller controls the scheduling operations of the downlink and the uplink in accordance with
a first criterion such that the uplink subframe of the user equipment starts, prior to termination of the downlink subframe of the base station, wherein the uplink subframe includes the control signal or the data signal, and the downlink subframe does not include the control signal and does not include the data signal;
a second criterion such that the uplink subframe of the user equipment starts, prior to the termination of the downlink subframe of the base station, wherein the uplink subframe does not include the control signal and does not include the data signal, and the downlink subframe includes the control signal or the data signal; or
a third criterion such that the uplink subframe of the user equipment starts, prior to the termination of the downlink subframe of the base station, wherein the uplink subframe includes a signal other than an acknowledgement signal, and the downlink subframe includes the control signal or the data signal.

2. The base station according to claim 1,
wherein, in the second criterion or the third criterion, the downlink subframe of the base station, the downlink subframe including the control signal or the data signal, includes the data signal to which data modulation and channel coding are applied in accordance with a MCS level with which a throughput greater than or equal to a predetermined value is achievable, and
wherein the MCS level is a parameter that specifies any of predetermined combinations of data modulation schemes and channel coding schemes.

3. The base station according to claim 1,
wherein, when the second criterion or the third criterion is used, the DL scheduler performs the scheduling based on the error detection result with respect to another downlink subframe and the downlink channel quality information, without considering the error detection result with respect to the downlink subframe of the base station, wherein the downlink subframe of the base station is terminated subsequent to starting the uplink subframe of the user equipment.

4. The base station according to claim 1,
wherein timing of a boundary between the downlink subframe and the uplink subframe is set for each of units of the user equipment.

5. The base station according to claim 1,
wherein, in the mobile communication system, a period corresponding to a third predetermined number of subframes are defined, wherein the third predetermined number is a sum of a first predetermined number and a second predetermined number, and
wherein the base station receives the channel quality information from the user equipment at least on a basis of the period.

6. The base station according to claim 5,
wherein the period corresponding to the third predetermined number of the subframes is a multiple of a time interval of a radio frame including a predetermined number of the subframes.

7. A resource allocation method used for a base station of a mobile communication system that performs communication based on a half duplex frequency division duplex, the base station comprising:
a UL scheduler that performs scheduling of a control signal and a data signal in an uplink; and
a DL scheduler that performs the scheduling of the control signal and the data signal in a downlink, based on downlink channel quality information measured by user equipment and an error detection result with respect to the data signal received by the user equipment,
wherein, in the mobile communication system, a frame is repeated such that in the frame a first predetermined number of downlink subframes are continued, and subsequently a second predetermined number of uplink subframes are continued, and
wherein the resource allocation method performs the scheduling of the downlink and the uplink in accordance with
a first criterion such that the uplink subframe of the user equipment starts, prior to termination of the downlink subframe of the base station, wherein the uplink subframe includes the control signal or the data signal, and the downlink subframe does not include the control signal and does not include the data signal;
a second criterion such that the uplink subframe of the user equipment starts, prior to the termination of the downlink subframe of the base station, wherein the uplink subframe does not include the control signal and does not include the data signal, and the downlink subframe includes the control signal or the data signal; or
a third criterion such that the uplink subframe of the user equipment starts, prior to the termination of the downlink subframe of the base station, wherein the uplink subframe includes a signal other than an acknowledgement signal, and the downlink subframe includes the control signal or the data signal.
